(19) United States
(12) Patent Application Publication
(10) Pub. No.: US 2025/0202146 A1
(43) Pub. Date: Jun. 19, 2025

(54) FLOATING BOARD-TO-BOARD POWER CONNECTORS

(71) Applicant: Amphenol Aorora Technology (Huizhou) Co., Ltd., Huizhou (CN)

(72) Inventors: Qi Han, Huizhou (CN); Ziaohong Zhu, Huizhou (CN)

(73) Assignee: Amphenol Aorora Technology (Huizhou) Co., Ltd., Huizhou (CN)

(21) Appl. No.: 18/984,938

(22) Filed: Dec. 17, 2024

(30) Foreign Application Priority Data
Dec. 18, 2023 (CN) 202323457247.X

(51) Int. Cl. H01R 12/91; H01R 12/71

(52) U.S. Cl. CPC H01R 12/91; H01R 12/716

(57) ABSTRACT

A floating board-to-board connector system is provided. The system includes a receptacle connector and a plug connector configured to mate with each other. The receptacle connector includes outer and inner housing portions. The inner housing portion includes a slot and a tongue extending into the slot. Receptacle terminals comprise mating ends disposed along a side of the tongue, tails for mounting to a circuit board, and elastic intermediate portions configured to expand and/or shrink in a range of 0 to 1.0 mm. The plug connector includes upper and lower housing portions. The upper housing portion is configured to insert into the receptacle slot in a mating direction a distance that can vary in a range of 0 to 0.6 mm. The upper housing portion also comprises a slot. Each plug terminal includes multiple contact portions curving into the plug slot and configured to contact receptacle mating contact portions.

### CROSS-REFERENCE TO RELATED APPLICATIONS

This application claims priority to and the benefit of Chinese Patent Application Serial No. 202323457247.X, filed on Dec. 18, 2023, the contents of which are incorporated herein by reference in their entirety.

### TECHNICAL FIELD

This application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors.

### BRIEF SUMMARY

Aspects of the present disclosure relate to floating board-to-board power connectors.

Some embodiments relate to a receptacle connector. The receptacle connector may comprise a housing comprising an outer housing portion, an inner housing portion disposed in the outer housing portion, and a cavity between the outer housing portion and the inner housing portion, the inner housing portion comprising a slot and a tongue extending from a bottom of the inner housing portion into the slot; and a plurality of terminals, each of the plurality of terminals comprising a mating end disposed along a side of the tongue of the inner housing portion, a tail, and an elastic intermediate portion between the mating end and the tail, the intermediate portion at least partially disposed in the cavity between the outer housing portion and the inner housing portion.

Optionally, each elastic intermediate portion is configured to expand and/or shrink in a range of 0 to 1.0 mm.

Optionally, for each of the plurality of terminals, the mating end comprises a retention member fixedly disposed in a receiving member of the tongue of the inner housing portion so as to leave a gap between the mating end and the side of the tongue of the inner housing portion, and the tail fixedly disposed on the outer housing portion, such that the elastic intermediate portion can expand and/or shrink therebetween.

Optionally, for each of the plurality of terminals the elastic intermediate portion comprises a plurality of stripes separated by gaps.

Optionally, the terminal is capable of carrying a current of 3 A.

Optionally, the elastic intermediate portion comprises a U-shaped portion, and a plurality of bends at an end of the U-shaped portion.

Optionally, each of the plurality of bends extend in an obtuse angle.

Optionally, the U-shaped portion of the elastic intermediate portion comprises a plurality of stripes separated by gaps.

Optionally, the plurality of terminals are arranged at equal intervals to form two rows in a mirror-image distribution about the tongue of the inner housing portion.

Some embodiments relate to a plug connector. The plug connector may comprise a housing comprising a lower housing portion and an upper housing portion narrower than the lower housing portion, the upper housing portion comprising a slot; and a plurality of terminals, each of the plurality of terminals comprising a mating end disposed in the upper housing portion and along a side of the slot of the upper housing portion, a tail, and an intermediate portion between the mating end and the tail, the mating end comprising a plurality of beams, each of the plurality of beams comprising a mating contact portion curving into the slot of the upper housing portion.

Optionally, for each of the plurality of terminals, the mating end comprises two beams.

Optionally, the plurality of terminals are arranged at equal intervals to form two rows in a mirror-image distribution about the slot of the upper housing portion.

Optionally, the lower housing portion comprising a cavity connected to the slot of the upper housing portion; and a portion of the intermediate portion of each of the plurality of terminals is disposed in the cavity of the lower housing portion.

Optionally, the portion of the intermediate portion comprises a bend extending in an obtuse angle.

Optionally, each of the plurality of terminals is capable of carrying a current of 3 A.

Some embodiments relate to a board-to-board connector system. The board-to-board connector system may comprise a receptacle connector comprising a receptacle housing comprising a receptacle slot and a tongue extending from a bottom of the receptacle housing into the receptacle slot, and a plurality of receptacle terminals comprising mating contact portions aligned along a side of the tongue, and tails configured to mount to a first circuit board; and a plug connector configured to mate with the receptacle connector, the plug connector comprising a plug housing comprising a lower plug housing portion and an upper plug housing portion, the upper plug housing portion comprising a plug slot configured to receive the tongue of the receptacle housing of the receptacle connector and configured to insert into the receptacle slot of the receptacle housing in a mating direction a distance that can vary in a range of 0 to 0.6 mm, and a plurality of plug terminals comprising mating contact portions disposed in the upper plug housing portion and configured to electrically contact the mating contact portions of the plurality of receptacle terminals of the receptacle connector, and tails configured to mount to a second circuit board.

Optionally, the first circuit board and the second circuit board are configured to be parallel to each other; and each of the plurality of receptacle terminals is configured to expand and/or shrink in a range of 0 to 1.0 mm in a direction perpendicular to the mating direction.

Optionally, each of the plurality of receptacle terminals is capable of carrying a current of 3 A; and each of the plurality of plug terminals is capable of carrying a current of 3 A.

Optionally, the receptacle housing comprises a protrusion protruding from an inner wall of the receptacle housing; and the upper plug housing portion comprises a groove recessed from an outer wall of the upper plug housing portion and configured to receive the protrusion of the receptacle housing.

Optionally, each of the plurality of plug terminals comprises a plurality of mating contact portions curving into the plug slot of the upper plug housing portion.

Some embodiments relate to a board-to-board connector system. The board-to-board connector system may comprise a plug connector and a receptacle connector. The plug connector and the receptacle connector may be connected to each other by insertion. The plug connector may comprise a plug housing and multiple plug terminals. The multiple plug terminals may be disposed on the plug housing. The receptacle connector may comprise a receptacle housing and multiple receptacle terminals. The multiple receptacle terminals may be disposed on the receptacle housing. Each of the plug terminals may correspondingly electrically be connected to each of the receptacle terminals. The receptacle terminal may be provided with multiple gaps. The multiple gaps may be distributed at intervals in a width direction of the receptacle terminal.
the plug terminal may comprise a first mating end and a first intermediate portion connected to the first mating end. The first mating end may comprise two beams.

Optionally, the multiple plug terminals are arranged at equal intervals to form two rows in a mirror-image distribution, and the multiple receptacle terminals are arranged at equal intervals to form two rows in a mirror-image distribution.

Optionally, an end of the beam that is remote from the first intermediate portion forms a mating contact portion, the mating contact portion being used for electrical connection to the receptacle terminal.

Optionally, the receptacle terminal comprises a second mating end and a second intermediate portion connected to the second mating end, the second mating end being used for electrical connection to the two beams.

Optionally, the second intermediate portion is a U-shaped portion, and multiple first bends are formed at two ends of the U-shaped portion.

Optionally, an angle of the first bend is obtuse.

Optionally, the plug housing comprises a lower plug housing portion, a first slot being formed above the lower plug housing portion, and the first mating ends of the two rows of plug terminals being respectively disposed on inner walls at two sides of the first slot.

Optionally, the receptacle housing comprises a receptacle inner housing portion and a receptacle outer housing portion fitted round the outside of the receptacle inner housing portion, a second slot being formed on the receptacle inner housing portion, a tongue being formed at the bottom of the interior of the second slot, the second mating ends of the two rows of receptacle terminals being respectively disposed along two side faces of the tongue, and the first slot being inserted in the second slot.

Optionally, a groove is formed on an outer wall of the first slot, and a protrusion matching the groove is formed on an inner wall of the second slot.

Optionally, grooves are provided at two ends of the lower plug housing portion and the receptacle outer housing portion, and board holders are provided in the grooves.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a perspective view of a board-to-board connector system comprising a plug connector and a receptacle connector, according to some embodiments.

FIG. 2 is a perspective view of a receptacle terminal of the receptacle connector of the board-to-board connector system of FIG. 1.

FIG. 3 is a perspective view of a plug terminal of the plug connector of the board-to-board connector system of FIG. 1.

FIG. 4 is a perspective view of the receptacle connector of the board-to-board connector system of FIG. 1, with a receptacle housing hidden.

FIG. 5 is a perspective view of plug terminals of the plug connector of the board-to-board connector system of FIG. 1, with a plug housing hidden.

FIG. 6 is a side view of the plug terminal of FIG. 3.

FIG. 7 is a side view of the receptacle terminal of FIG. 2.

FIG. 8 is a perspective view of the plug housing of the plug connector of the board-to-board connector system of FIG. 1.

FIG. 9 is a perspective view of the receptacle housing of the receptacle connector of the board-to-board connector system of FIG. 1.

FIG. 10 is a cross-sectional view of the board-to-board connector system when mated along a line marked “10-10” in FIG. 2.

### DETAILED DESCRIPTION

The inventors have recognized and appreciated techniques for making floating board-to-board connector systems for use in a harsh environment such as one presented by an automobile. Techniques described herein may enable connectors that have terminals capable of carrying a high current (e.g., 3 A), while satisfying reliability requirements of industry standards (e.g., USCAR-2-V2) with floating terminals capable of expanding and/or shrinking to accommodate manufacture and/or assembly variations. Techniques described herein may also enable a connector system capable of reliably operating in a range of heights. For example, a plug connector may be configured for inserting into a receptacle connector in a mating direction by a distance that can vary in a range of 0 to 0.60 mm. For example, if the nominal mating height (fully mated) of a system is 13.0 mm, the system can operate reliably in a mating height range of 13.00 mm to 13.60 mm.

According to aspects of the present disclosure, a board-to-board connector system can include a receptacle connector and a plug connector. In some embodiments, the connectors may be mounted to circuit boards, respectively, and then mated to electrically connector the circuit boards. The connectors may be configured to allow for ±1.0 mm floating tolerance during mating to accommodate manufacture and/or assembly variations. The connector may have terminals capable of carrying a current of up to 3 A.

In some embodiments, the receptacle connector may include a housing having an outer housing portion and an inner housing portion. The inner housing portion may include a slot and a tongue extending from the bottom of the inner housing portion into the slot. A plurality of receptacle terminals may be held by the housing. Each receptacle terminal may comprise a mating end disposed along a side of the tongue of the inner housing portion, a tail for mounting to a circuit board, and an elastic intermediate portion between the mating end and the tail. The elastic intermediate portion may be configured to expand and/or shrink in a range of 0 to 1.0 mm. The elastic intermediate portion may include a plurality of stripes separated by gaps. In some embodiments, the elastic intermediate portion may include a U-shaped portion having a plurality of bends at an end. Each bend extends in an obtuse angle. Such a configuration may enable the connector capable of both floating during mating and reliably carrying a high current.

In some embodiments, the plug connector may include a housing having upper and lower housing portions. The upper housing portion may be narrower than the lower housing portion and configured to insert into the receptacle slot in a mating direction a distance that can vary in a range of 0 to 0.6 mm. The upper housing portion may comprise a slot. Each plug terminal may include a mating end disposed along a side of the slot of the upper housing portion, a tail for mounting to a circuit board, and an intermediate portion between the mating end and the tail. Each mating end may include multiple contact portions curving into the slot of the upper housing portion and configured to contact receptacle mating contact portions. The lower housing portion may include a cavity. A portion of the intermediate portion of each plug terminal is disposed in the cavity of the lower housing portion. The portion of the intermediate portion may include a bend extending in an obtuse angle. Such a configuration may enable the connector capable of both floating during mating and reliably carrying a high current.

In some embodiments, the inner housing portion of the receptacle connector and the upper housing portion of the plug connector may include matching features configured to enable a range of reliable insertion distances. For example, the inner housing portion of the receptacle connector may comprise a protrusion protruding from an inner wall of the inner housing portion of the receptacle connector. The upper housing portion of the plug connector may comprise a groove recessed from an outer wall of the upper housing portion of the plug connector and configured to receive the protrusion of the inner receptacle housing.

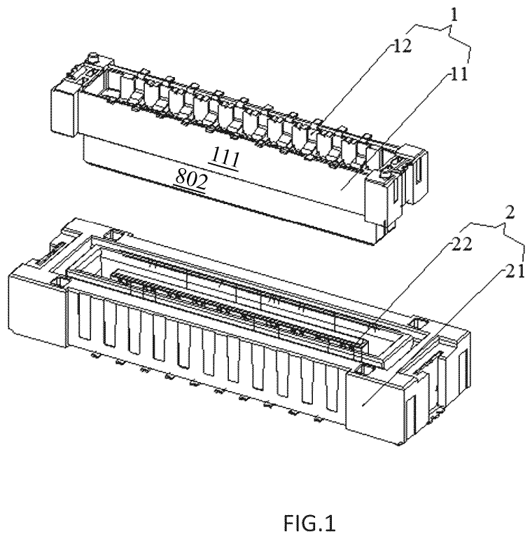

FIG. 1 is a perspective view of an exemplary board-to-board connector system. As illustrated, the board-to-board connector system may comprise a plug connector 1 and a receptacle connector 2 configured to mate with each other by, for example, insertion. As illustrated, the plug connector 1 comprises a plug housing 11 and multiple plug terminals 12, the multiple plug terminals 12 being disposed on the plug housing 11. As illustrated, the receptacle connector 2 comprises a receptacle housing 21 and multiple receptacle terminals 22 held by the receptacle housing 21. Each plug terminal 12 may be configured to electrically connected to a respective receptacle terminal 22.

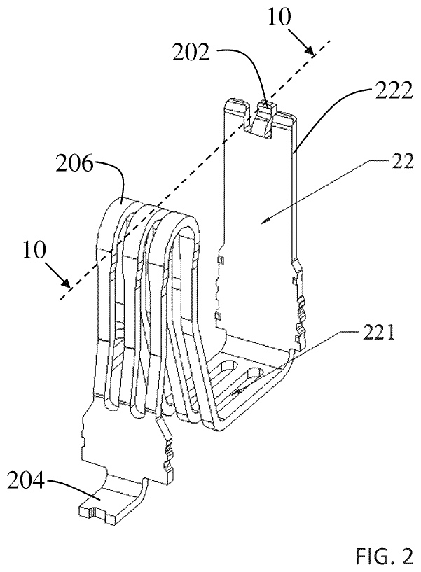

FIG. 2 is a perspective view of a receptacle terminal 22 of the receptacle connector 2. In the illustrated example, the receptacle terminal 22 comprises multiple gaps 221 distributed at intervals in a width direction of the receptacle terminal 22. In some embodiments, the multiple gaps 221 may be distributed in parallel. The width of each gap 221 may be less than the width of the interval between gaps 221.

The multiple gaps 221 may provide space for deformation of the receptacle terminal 22, enabling the receptacle terminal 22 to adapt to installation position offset during installation, and deform according to the offset, so as to meet a requirement for floating during installation. The multiple gaps 221 in the receptacle terminal 22 may enable the receptacle terminal 22 to carry a larger current, so as to meet a requirement for transmission of a large current, and achieve efficient transmission. In the illustrated example, the receptacle terminal can carry a current of 3 A.

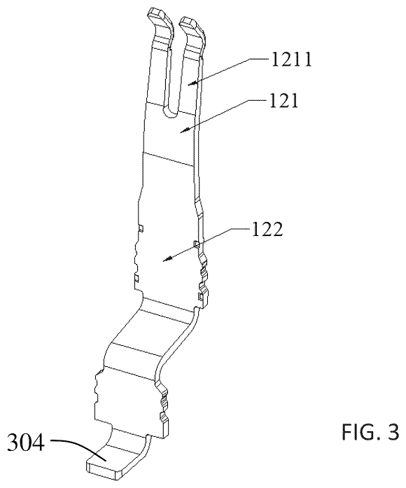

FIG. 3 is a perspective view of a plug terminal 12 of the plug connector 1. In the illustrated example, the plug terminal 12 comprises a first mating end 121, a first tail 304, and a first intermediate portion 122 between the first mating end 121 and the first tail 304. The first mating end 121 may include two beams 1211. In some embodiments, the two beams 1211 are connected, side by side, to one end of the first intermediate portion 122. The two beams 1211 may be correspondingly electrically connected to one receptacle terminal 22 such that the plug terminal 12 is configured with two contact positions at the first mating end 121. Such a configuration can increase the stability of signal transmission between the plug terminal 12 and the receptacle terminal 22, especially in environmental conditions with vibration such as vehicles, ensuring high stability of signal transmission.

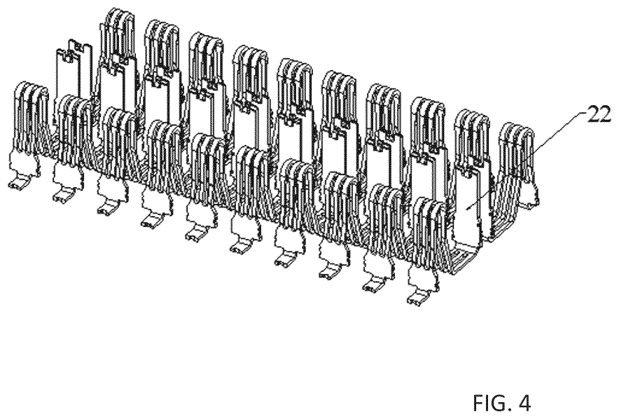

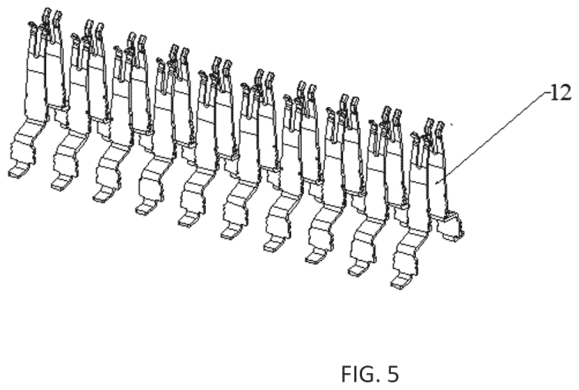

FIG. 4 is a perspective view of the receptacle connector 2, with the receptacle housing 21 hidden, showing the multiple plug terminals 12. FIG. 5 is a perspective view of plug terminals 12 of the plug connector 1, with the plug housing 11 hidden, showing the multiple receptacle terminals 22. In some embodiments, the multiple receptacle terminals 22 may be arranged at equal intervals to form two rows in a mirror-image distribution. The multiple plug terminals 12 and multiple receptacle terminals 22 may correspond to each other in number and position, with one plug terminal 12 correspondingly electrically connected to one receptacle terminal 22.

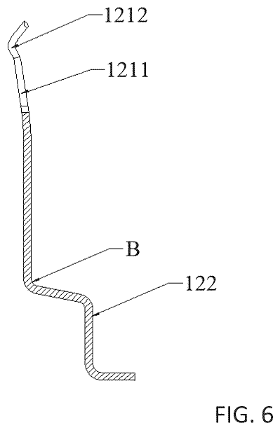

FIG. 6 is a side view of the plug terminal 12. In the illustrated example, an end of the beam 1211 that is remote from the first intermediate portion 122 forms a mating contact portion 1212 configured for making electrical connection to the receptacle terminal 22. A bend on the mating contact portion 1212 may contact the receptacle terminal 22 to achieve an electrical connection, such that a position of contact between the plug terminal 12 and the receptacle terminal 22 changes from a contact surface to a contact point. Such a configuration can make the transmission of signals or current more concentrated, with higher transmission efficiency. In the illustrated example, the mating contact portion 1212 has a floating space for elongation and extension so as to meet a requirement for floating during installation. The mating contact portion 1212 may be able to deform according to an offset in installation position during installation so as to achieve a stable connection and ensure the stability of transmission.

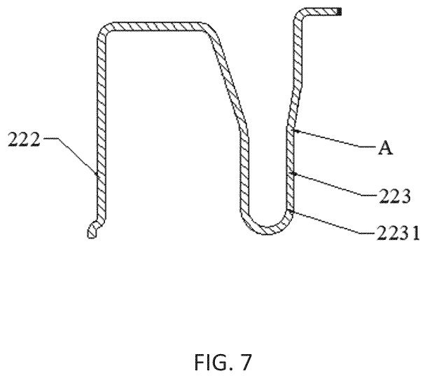

FIG. 7 is a side view of the receptacle terminal 22. In the illustrated example, the receptacle terminal 22 comprises a second mating end 222, a second tail 204, and a second intermediate portion 223 between the second mating end 222 and the second tail 204. The second mating end 222 may be configured for electrical connection to the two beams 1211. As illustrated, the second mating end 222 may be configured to be electrically connected to the mating contact portions 1212 on the two beams 1211.

As illustrated, the second intermediate portion 223 may include a U-shaped portion 2231. Multiple first bends A may be formed at two ends of the U-shaped portion 2231. A rounded bend may be formed in the U-shaped portion 2231. Such a configuration may provide space for deformation of structures at two ends of the rounded bend so as to meet a requirement for floating during installation of the receptacle terminal. Such a configuration may aid in dispersing stress during floating of the receptacle, enabling the receptacle terminal to promptly recover its original shape when floating ends.

In the illustrated example, the first bend A may extend in an obtuse angle, which may enable the receptacle terminal 22 to elongate and extend more effectively during floating. Providing multiple first bends A may enable elongation and extension of the receptacle terminal 22 at various positions, so as to meet requirements for floating at different installation positions, and thus achieve a better floating effect. In this example, the receptacle terminal 22 can float in the range of ±1.0 mm.

In some embodiments, multiple second bends B may also be formed in the first intermediate portion 122. The second bend B may extend in an obtuse angle, which make enable achieving the same floating effect as that of the receptacle terminal 22.

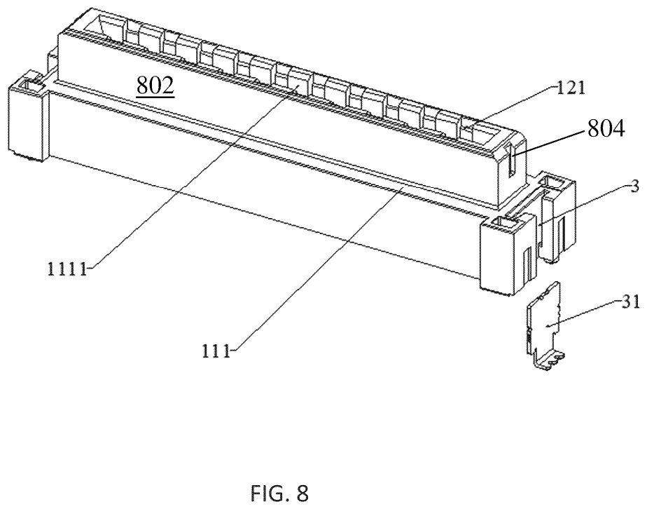

FIG. 8 is a perspective view of the plug housing 11 of the plug connector 1. In the illustrated example, the plug housing 11 comprises an upper plug housing portion 802 and a lower plug housing portion 111. A first slot 1111 may be formed in the upper plug housing portion 802 and above the lower plug housing portion 111. The first mating ends 121 of the two rows of plug terminals 12 may be respectively disposed along inner walls at two sides of the first slot 1111.

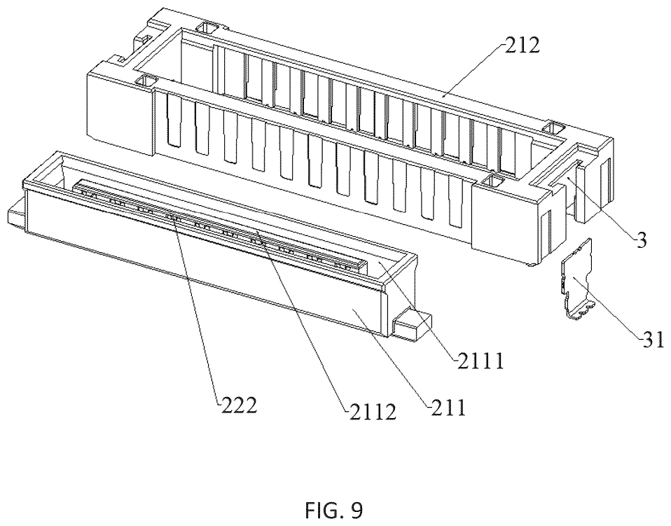

FIG. 9 is a perspective view of the receptacle housing 21 of the receptacle connector 2. In the illustrated example, the receptacle housing 21 comprises a receptacle inner housing portion 211, and a receptacle outer housing portion 212 disposed outside of the receptacle inner housing portion 211. A second slot 2111 may be formed on the receptacle inner housing portion 211. A tongue 2112 may extend from the bottom of the receptacle inner housing portion 211 into the second slot 2111. The second mating ends 222 of the two rows of receptacle terminals 22 may be respectively disposed along two side faces of the tongue 2112.

In some embodiments, a retention member 202 may be formed at an end of the second mating end 222 that is remote from the second intermediate portion 223. A receiving member 1006 may be formed on the tongue 2112 and configured to receive the retention member 202 of the second mating end 222 of the receptacle terminal 22, leaving a gap 1008 between the second mating end 222 and the tongue 2112. Engaging the retention member 202 of the receptacle terminal 22 with receiving member 1006 of the tongue 2112 may enable the second mating end 222 to be disposed on the tongue 2112 more securely. Such a configuration may enable more stable connection between the second mating end 222 and the first mating end 121, ensuring the stability of transmission.

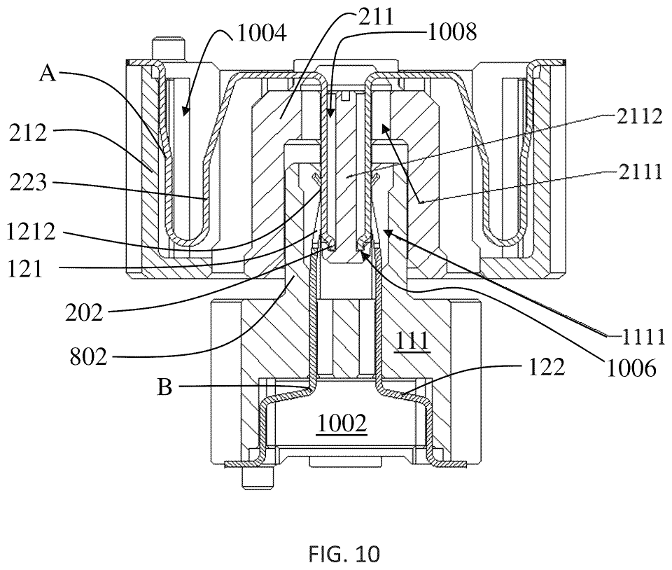

FIG. 10 is a cross-sectional view of the board-to-board connector system when mated along a line marked “10-10” in FIG. 2. In the illustrated example, the lower plug housing portion 111 may include a cavity 1002 located below the first slot 1111. A portion of the first intermediate portion 122 comprising the second bend B may be disposed in the cavity, and therefore movable in the cavity 1002. The first mating end 121 may be disposed along an inner wall of the first slot 1111. In some embodiments, the first mating end 121 may be inserted into the first slot 1111 via a through-hole at the bottom of the first slot 1111.

In some embodiments, a cavity 1004 formed between the receptacle inner housing portion 211 and the receptacle outer housing portion 212. A portion of the second intermediate portion 223 comprising the first bends A may be disposed in the cavity 1004. The second mating end 222 may be partially disposed along a side face of the tongue 2112. In some embodiments, the second mating end 222 may be inserted into the second slot 2111 via a through-hole at the bottom of the second slot 2111. The second intermediate portion 223 may be disposed in the cavity 1004 between the receptacle inner housing portion 211 and the receptacle outer housing portion 212.

The upper plug housing portion 802 comprising the first slot 1111 may be configured to be inserted into the second slot 2111. In some embodiments, the upper plug housing portion 802 may be configured to be fully or partially inserted into the second slot 2111, which may enable different mated heights of the plug connector 1 and the receptacle connector 2. In the illustrated example, a variation of an insertion distance between the plug connector 1 and the receptacle connector 2 can be in the range of 0 to 0.6 mm. For example, if the mated height is 13.0 mm when the plug connector 1 is fully inserted in the receptacle connector 2, then the maximum mated height when the plug connector 1 is not fully inserted in the receptacle connector 2 is 13.6 mm. Different mated heights can therefore be achieved by adjusting the insertion distance, so as to meet different installation requirements, providing a high level of versatility.

Referring back to FIGS. 8-9, in the illustrated example, a groove 804 may be formed on an outer wall of the first slot 1111, and a protrusion matching the groove may be formed on an inner wall of the second slot 2111. In some embodiments, the groove 804 of the first slot 1111 may instead be configured to be a protrusion, and the protrusion of the second slot 2111 may instead be configured to be a groove. In this example, zero-gap engagement may be realized between the groove and the protrusion, such that the upper plug housing portion 802 comprising the first slot 1111 can be tightly inserted in the second slot 2111, to reduce the risk of the upper plug housing portion 802 accidentally being loosened or detached from the second slot 2111 in environmental conditions with vibration such as vehicles, and ensure the stability of connection between the plug terminal 12 and the receptacle terminal 22, to realize highly stable transmission.

In the illustrated example, grooves 3 are provided at two ends of the lower plug housing portion 111 and the receptacle outer housing portion 212, and board holders 31 are provided in the grooves 3. The board holders 31 are configured for connecting to circuit boards, and can fixedly install the plug connector 1 and the receptacle connector 2 on corresponding circuit boards respectively, so as to transmit current or signals.

Various aspects are described in this disclosure, which include, but are not limited to, the following aspects:
1. A board-to-board connector system, comprising a plug connector (e.g., 1) and a receptacle connector (e.g., 2), the plug connector (e.g., 1) and the receptacle connector (e.g., 2) being connected to each other by insertion; the plug connector (e.g., 1) comprising a plug housing (e.g., 11) and multiple plug terminals (e.g., 12), the multiple plug terminals (e.g., 12) being disposed on the plug housing (e.g., 11); the receptacle connector (e.g., 2) comprising a receptacle housing (e.g., 21) and multiple receptacle terminals (e.g., 22), the multiple receptacle terminals (e.g., 22) being disposed on the receptacle housing (e.g., 21), and each of the plug terminals (e.g., 12) being correspondingly electrically connected to each of the receptacle terminals (e.g., 22); the receptacle terminal (e.g., 22) being provided with multiple gaps (e.g., 221), the multiple gaps (e.g., 221) being distributed at intervals in a width direction of the receptacle terminal (e.g., 22); the plug terminal (e.g., 12) comprising a first mating end (e.g., 121) and a first intermediate portion (e.g., 122) connected to the first mating end (e.g., 121), the first mating end (e.g., 121) comprising two beams (e.g., 1211).
2. The board-to-board connector system of aspect 1, wherein the multiple plug terminals (e.g., 12) are arranged at equal intervals to form two rows in a mirror-image distribution, and the multiple receptacle terminals (e.g., 22) are arranged at equal intervals to form two rows in a mirror-image distribution.
3. The board-to-board connector system of aspect 2, wherein an end of the beam (e.g., 1211) that is remote from the first intermediate portion (e.g., 122) forms a mating contact portion (e.g., 1212), the mating contact portion (e.g., 1212) being used for electrical connection to the receptacle terminal (e.g., 22).
4. The board-to-board connector system of aspect 2, wherein the receptacle terminal (e.g., 22) comprises a second mating end (e.g., 222) and a second intermediate portion (e.g., 223) connected to the second mating end, the second mating end (e.g., 222) being used for electrical connection to the two beams (e.g., 1211).
5. The board-to-board connector system of aspect 4, wherein the second intermediate portion (e.g., 223) is a U-shaped portion (e.g., 2231), and multiple first bends (e.g., A) are formed at two ends of the U-shaped portion (e.g., 2231).
6. The board-to-board connector system of aspect 5, wherein an angle of the first bend (e.g., A) is obtuse.
7. The board-to-board connector system of aspect 4, wherein the plug housing (e.g., 11) comprises a lower plug housing portion (e.g., 111), a first slot (e.g., 1111) being formed above the plug housing portion (e.g., 111), and the first mating ends (e.g., 121) of the two rows of plug terminals (e.g., 12) being respectively disposed along inner walls at two sides of the first slot (e.g., 1111).
8. The board-to-board connector system of aspect 7, wherein the receptacle housing (e.g., 21) comprises a receptacle inner housing portion (e.g., 211) and a receptacle outer housing portion (e.g., 212) fitted round the outside of the receptacle inner housing portion (e.g., 211), a second slot (e.g., 2111) being formed on the receptacle inner housing portion (e.g., 211), a tongue (e.g., 2112) being formed at the bottom of the interior of the second slot (e.g., 2111), the second mating ends (e.g., 222) of the two rows of receptacle terminals (e.g., 22) being respectively disposed along two side faces of the tongue (e.g., 2112), and the first slot (e.g., 1111) being inserted in the second slot (e.g., 2111).
9. The board-to-board connector system of aspect 8, wherein a groove is formed on an outer wall of the first slot (e.g., 1111), and a protrusion matching the groove is formed on an inner wall of the second slot (e.g., 2111).
10. The board-to-board connector system of aspect 8, wherein grooves (e.g., 3) are provided at two ends of the lower plug housing portion (e.g., 111) and the receptacle outer housing portion (e.g., 212), and board holders (e.g., 31) are provided in the grooves (e.g., 3).
11. A receptacle connector (e.g., 2) comprising a housing (e.g., 21) comprising an outer housing portion (e.g., 212), an inner housing portion (e.g., 211) disposed in the outer housing portion, and a cavity (e.g., 1004) between the outer housing portion and the inner housing portion, the inner housing portion comprising a slot (e.g., 2111) and a tongue (e.g., 2112) extending from a bottom of the inner housing portion into the slot; and a plurality of terminals (e.g., 22), each of the plurality of terminals comprising a mating end (e.g., 222) disposed along a side of the tongue of the inner housing portion, a tail, and an elastic intermediate portion between the mating end and the tail (e.g., 204), the intermediate portion (e.g., 223) at least partially disposed in the cavity between the outer housing portion and the inner housing portion.
12. The receptacle connector of aspect 11, wherein each elastic intermediate portion is configured to expand and/or shrink in a range of 0 to 1.0 mm.
13. The receptacle connector of aspect 12, wherein for each of the plurality of terminals, the mating end comprises a retention member (e.g., 202) fixedly disposed in a receiving member (e.g., 1006) of the tongue of the inner housing portion so as to leave a gap (e.g., 1008) between the mating end and the side of the tongue of the inner housing portion, and the tail fixedly disposed on the outer housing portion, such that the elastic intermediate portion can expand and/or shrink therebetween.
14. The receptacle connector of aspect 11, wherein, for each of the plurality of terminals the elastic intermediate portion comprises a plurality of stripes (e.g., 206) separated by gaps (e.g., 221).
15. The receptacle connector of aspect 14, wherein the terminal is capable of carrying a current of 3 A.
16. The receptacle connector of aspect 14, wherein the elastic intermediate portion comprises a U-shaped portion (e.g., 2231), and a plurality of bends (e.g., A) at an end of the U-shaped portion.
17. The receptacle connector of aspect 16, wherein each of the plurality of bends extend in an obtuse angle.
18. The receptacle connector of aspect 17, wherein the U-shaped portion of the elastic intermediate portion comprises a plurality of stripes (e.g., 206) separated by gaps (e.g., 221).
19. The receptacle connector of aspect 11, wherein the plurality of terminals are arranged at equal intervals to form two rows in a mirror-image distribution about the tongue of the inner housing portion.
20. A plug connector (e.g., 1) comprising a housing comprising a lower housing portion (e.g., 111) and an upper housing portion (e.g., 802) narrower than the lower housing portion, the upper housing portion comprising a slot (e.g., 1111); and a plurality of terminals (e.g., 12), each of the plurality of terminals comprising a mating end (e.g., 121) disposed in the upper housing portion and along a side of the slot of the upper housing portion, a tail (e.g., 304), and an intermediate portion (e.g., 122) between the mating end and the tail, the mating end comprising a plurality of beams (e.g., 1211), each of the plurality of beams comprising a mating contact portion curving into the slot of the upper housing portion.
21. The plug connector of aspect 20, wherein, for each of the plurality of terminals, the mating end comprises two beams.
22. The plug connector of aspect 20, wherein the plurality of terminals are arranged at equal intervals to form two rows in a mirror-image distribution about the slot of the upper housing portion.
23. The plug connector of aspect 20, wherein the lower housing portion comprising a cavity (e.g., 1002) connected to the slot of the upper housing portion; and a portion of the intermediate portion of each of the plurality of terminals is disposed in the cavity of the lower housing portion.
24. The plug connector of aspect 23, wherein the portion of the intermediate portion comprises a bend (e.g., B) extending in an obtuse angle.
25. The plug connector of aspect 20, wherein each of the plurality of terminals is capable of carrying a current of 3 A.
26. A board-to-board connector system, comprising a receptacle connector (e.g., 2) comprising a receptacle housing comprising a receptacle slot and a tongue extending from a bottom of the receptacle housing into the receptacle slot, and a plurality of receptacle terminals comprising mating contact portions aligned along a side of the tongue, and tails configured to mount to a first circuit board; and a plug connector (e.g., 1) configured to mate with the receptacle connector, the plug connector comprising a plug housing comprising a lower plug housing portion and an upper plug housing portion, the upper plug housing portion comprising a plug slot configured to receive the tongue of the receptacle housing of the receptacle connector and configured to insert into the receptacle slot of the receptacle housing in a mating direction a distance that can vary in a range of 0 to 0.6 mm, and a plurality of plug terminals comprising mating contact portions disposed in the upper plug housing portion and configured to electrically contact the mating contact portions of the plurality of receptacle terminals of the receptacle connector, and tails configured to mount to a second circuit board.
27. The system of aspect 26, wherein the first circuit board and the second circuit board are configured to be parallel to each other; and each of the plurality of receptacle terminals is configured to expand and/or shrink in a range of 0 to 1.0 mm in a direction perpendicular to the mating direction.
28. The system of aspect 27, wherein each of the plurality of receptacle terminals is capable of carrying a current of 3 A; and each of the plurality of plug terminals is capable of carrying a current of 3 A.
29. The system of aspect 26, wherein the receptacle housing comprises a protrusion protruding from an inner wall of the receptacle housing; and the upper plug housing portion comprises a groove (e.g., 804) recessed from an outer wall of the upper plug housing portion and configured to receive the protrusion of the receptacle housing.
30. The system of aspect 29, wherein each of the plurality of plug terminals comprises a plurality of mating contact portions curving into the plug slot of the upper plug housing portion.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear,” “upper,” “lower,” “left,” “right,” “transverse direction,” “vertical direction,” “perpendicular,” “horizontal,” “top,” “bottom” and the like are shown based on the accompanying drawings, for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on,” “above,” “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features.” Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within +3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also enables that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector comprising:
a housing comprising an outer housing portion, an inner housing portion disposed in the outer housing portion, and a cavity between the outer housing portion and the inner housing portion, the inner housing portion comprising a slot and a tongue extending from a bottom of the inner housing portion into the slot; and
a plurality of terminals, each of the plurality of terminals comprising a mating end disposed along a side of the tongue of the inner housing portion, a tail, and an elastic intermediate portion between the mating end and the tail, the intermediate portion at least partially disposed in the cavity between the outer housing portion and the inner housing portion.

2. The receptacle connector of claim 1, wherein:
each elastic intermediate portion is configured to expand and/or shrink in a range of 0 to 1.0 mm.

3. The receptacle connector of claim 2, wherein:
for each of the plurality of terminals, the mating end comprises a retention member fixedly disposed in a receiving member of the tongue of the inner housing portion so as to leave a gap between the mating end and the side of the tongue of the inner housing portion, and the tail fixedly disposed on the outer housing portion, such that the elastic intermediate portion can expand and/or shrink therebetween.

4. The receptacle connector of claim 1, wherein, for each of the plurality of terminals:
the elastic intermediate portion comprises a plurality of stripes separated by gaps.

5. The receptacle connector of claim 4, wherein:
the terminal is capable of carrying a current of 3 A.

6. The receptacle connector of claim 4, wherein:
the elastic intermediate portion comprises a U-shaped portion, and a plurality of bends at an end of the U-shaped portion.

7. The receptacle connector of claim 6, wherein:
each of the plurality of bends extend in an obtuse angle.

8. The receptacle connector of claim 7, wherein:
the U-shaped portion of the elastic intermediate portion comprises a plurality of stripes separated by gaps.

9. The receptacle connector of claim 1, wherein:
the plurality of terminals are arranged at equal intervals to form two rows in a mirror-image distribution about the tongue of the inner housing portion.

10. A plug connector comprising:
a housing comprising a lower housing portion and an upper housing portion narrower than the lower housing portion, the upper housing portion comprising a slot; and
a plurality of terminals, each of the plurality of terminals comprising a mating end disposed in the upper housing portion and along a side of the slot of the upper housing portion, a tail, and an intermediate portion between the mating end and the tail, the mating end comprising a plurality of beams, each of the plurality of beams comprising a mating contact portion curving into the slot of the upper housing portion.

11. The plug connector of claim 10, wherein, for each of the plurality of terminals:
the mating end comprises two beams.

12. The plug connector of claim 10, wherein:
the plurality of terminals are arranged at equal intervals to form two rows in a mirror-image distribution about the slot of the upper housing portion.

13. The plug connector of claim 10, wherein:
the lower housing portion comprising a cavity connected to the slot of the upper housing portion; and
a portion of the intermediate portion of each of the plurality of terminals is disposed in the cavity of the lower housing portion.

14. The plug connector of claim 13, wherein:
the portion of the intermediate portion comprises a bend extending in an obtuse angle.

15. The plug connector of claim 10, wherein:
each of the plurality of terminals is capable of carrying a current of 3 A.

16. A board-to-board connector system, comprising:
a receptacle connector comprising:
a receptacle housing comprising a receptacle slot and a tongue extending from a bottom of the receptacle housing into the receptacle slot, and
a plurality of receptacle terminals comprising mating contact portions aligned along a side of the tongue, and tails configured to mount to a first circuit board; and
a plug connector configured to mate with the receptacle connector, the plug connector comprising:
a plug housing comprising a lower plug housing portion and an upper plug housing portion, the upper plug housing portion comprising a plug slot configured to receive the tongue of the receptacle housing of the receptacle connector and configured to insert into the receptacle slot of the receptacle housing in a mating direction a distance that can vary in a range of 0 to 0.6 mm, and
a plurality of plug terminals comprising mating contact portions disposed in the upper plug housing portion and configured to electrically contact the mating contact portions of the plurality of receptacle terminals of the receptacle connector, and tails configured to mount to a second circuit board.

17. The system of claim 16, wherein:
the first circuit board and the second circuit board are configured to be parallel to each other; and
each of the plurality of receptacle terminals is configured to expand and/or shrink in a range of 0 to 1.0 mm in a direction perpendicular to the mating direction.

18. The system of claim 17, wherein:
each of the plurality of receptacle terminals is capable of carrying a current of 3 A; and
each of the plurality of plug terminals is capable of carrying a current of 3 A.

19. The system of claim 16, wherein:
the receptacle housing comprises a protrusion protruding from an inner wall of the receptacle housing; and
the upper plug housing portion comprises a groove recessed from an outer wall of the upper plug housing portion and configured to receive the protrusion of the receptacle housing.

20. The system of claim 19, wherein:
each of the plurality of plug terminals comprises a plurality of mating contact portions curving into the plug slot of the upper plug housing portion.
